(19) United States
(12) Patent Application Publication
(10) Pub. No.: US 2017/0273292 A1
(43) Pub. Date: Sep. 28, 2017

(54) FLY CATCHER COMBINATION

(71) Applicants: Beto Engineering & Marketing Co., Ltd., Taichung (TW); Expectations, LLC, Puyallup, WA (US)

(72) Inventors: Christopher Henry LEIER, Taichung, WA (US); Lo Pin Wang, Taichung (TW)

(21) Appl. No.: 15/076,761

(22) Filed: Mar. 22, 2016

(51) Int. Cl. A01M 1/10

(52) U.S. Cl. CPC A01M 1/106

(57) ABSTRACT

A fly catcher combination includes a frame having an opening formed by a peripheral fence, an attachment attached to the frame for attaching to a supporting facility, and a receptacle engaged in the opening of the frame and supported on the frame, and the receptacle includes a housing having a chamber, and a cover engaged with the housing, and the cover includes a compartment formed in the cover and communicating with the chamber of the housing, and the cover includes one or more slots communicating with the compartment of the cover for allowing the flies or the mosquitos to fly into the compartment of the cover, but prevent the flies or the mosquitos from flying out of the receptacle.

### BACKGROUND OF THE INVENTION

1. Field of the Invention

The present invention relates to a fly catcher combination, and more particularly to a fly catcher combination including an improved and simplified structure or configuration that may be easily and quickly made or manufactured by the workers with a simplified making or manufacturing procedure and with a decreased manufacturing cost, and that may be easily and quickly attached or mounted or secured or coupled to various supporting facilities or the like.

2. Description of the Prior Art

Various kinds of typical fly catchers or mosquito lamps have been developed and provided for catching and removing flies and/or mosquitos, and normally comprise a housing for attracting and receiving the flies and/or the mosquitos, in which the typical mosquito lamps are required to be energized with electric power or energy. The other typical fly catchers have been developed and provided for catching and removing flies and/or mosquitos without electric power or energy.

For example, U.S. Pat. No. 4,141,173 to Welmert et al., U.S. Pat. No. 4,217,723 to Hrebec, U.S. Pat. No. 5,363,589 to Flynn, and U.S. Pat. No. 5,461,822 to Green et al. disclose several of the typical fly catchers each also comprising a housing for attracting and receiving the flies and/or the mosquitos.

However, the typical fly catcher includes a complicated structure or configuration that may not be easily and quickly made or manufactured by the workers, and that may include a complicated making or manufacturing procedure, and that may include a greatly increased manufacturing cost. In addition, the typical fly catchers may not be easily and quickly attached or mounted or secured or coupled to various supporting facilities, such as the garbage cans or the like.

The present invention has arisen to mitigate and/or obviate the afore-described disadvantages of the conventional fly catchers or the like.

### SUMMARY OF THE INVENTION

The primary objective of the present invention is to provide a fly catcher combination including an improved and simplified structure or configuration that may be easily and quickly made or manufactured by the workers with a simplified making or manufacturing procedure and with a decreased manufacturing cost, and that may be easily and quickly attached or mounted or secured or coupled to various supporting facilities or the like.

In accordance with one aspect of the invention, there is provided a fly catcher combination comprising a carrier including a frame having an opening formed therein and defined by a peripheral fence, an attachment attached to the frame of the carrier for attaching the frame of the carrier to a supporting facility, and a receptacle engaged in the opening of the frame and supported on the frame, and the receptacle including a housing having a chamber formed in the housing, and a cover engaged with the housing, and the cover including a compartment formed in the cover and communicating with the chamber of the housing, and the cover including at least one slot formed therein and communicating with the compartment of the cover for allowing the flies or the mosquitos to fly into the compartment of the cover, but prevent the flies or the mosquitos from flying out of the receptacle.

The carrier includes an ear extended from the frame for engaging with and for supporting the attachment. The attachment includes a first attaching member attached to the frame, and/or the attachment includes a second attaching member engaged with the first attaching member for attaching the frame of the carrier to the supporting facility.

The first and the attaching members are selected from magnetic attractive members for attracting with each other; or the first and the attaching members are selected from hook-and-loop attaching members for engaging with each other; or the first attaching member of the attachment is selected from an adhesive material for adhering or attaching the frame of the carrier to the supporting facility.

The housing includes an orifice formed therein and communicating with the chamber of the housing, and the cover includes a notch formed therein for selectively aligning with the orifice of the housing when the cover is rotated relative to the housing and for filling or introducing a water or fluid into the housing of the receptacle.

The cover includes a casing extended from an upper portion into the cover, and the casing includes a space formed therein and spaced from the compartment of the cover by the casing, the casing includes an aperture formed therein and communicating with the space of the casing and communicating with the compartment of the cover. The slot of the cover is formed in the casing and communicating with the compartment of the cover.

The housing includes a peripheral recess formed in an upper peripheral portion of the housing, and the cover includes a peripheral flange extended downwardly from a lower peripheral portion of the cover for slidably engaging with the peripheral recess of the housing and for guiding the cover to rotate relative to the housing.

The housing includes a channel formed therein, and the cover includes a key extended from the peripheral flange for slidably engaging with the channel of the housing and for guiding and limiting the cover to rotate relative to the housing.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a fly catcher combination in accordance with the present invention;

FIG. 2 is a cross sectional view of the fly catcher combination, taken along lines 2-2 of FIG. 1;

FIG. 3 is a partial exploded view of the fly catcher combination;

FIG. 4 is another partial exploded view of the fly catcher combination;

FIG. 5 is another perspective view similar to FIG. 1, illustrating the other arrangement of the fly catcher combination;

FIG. 6 is a cross sectional view of the fly catcher combination, taken along lines 6-6 of FIG. 5;

FIGS. 7, 8 are partial exploded views of the fly catcher combination as shown in FIGS. 5 and 6;

FIG. 9 is another cross sectional view similar to FIGS. 2 and 6, illustrating the further arrangement of the fly catcher combination; and

FIGS. 10, 11 are cross sectional views similar to FIGS. 2, 6, and 9, illustrating the still further arrangement of the fly catcher combination.

### DETAILED DESCRIPTION OF THE PREFERRED EMBODIMENT

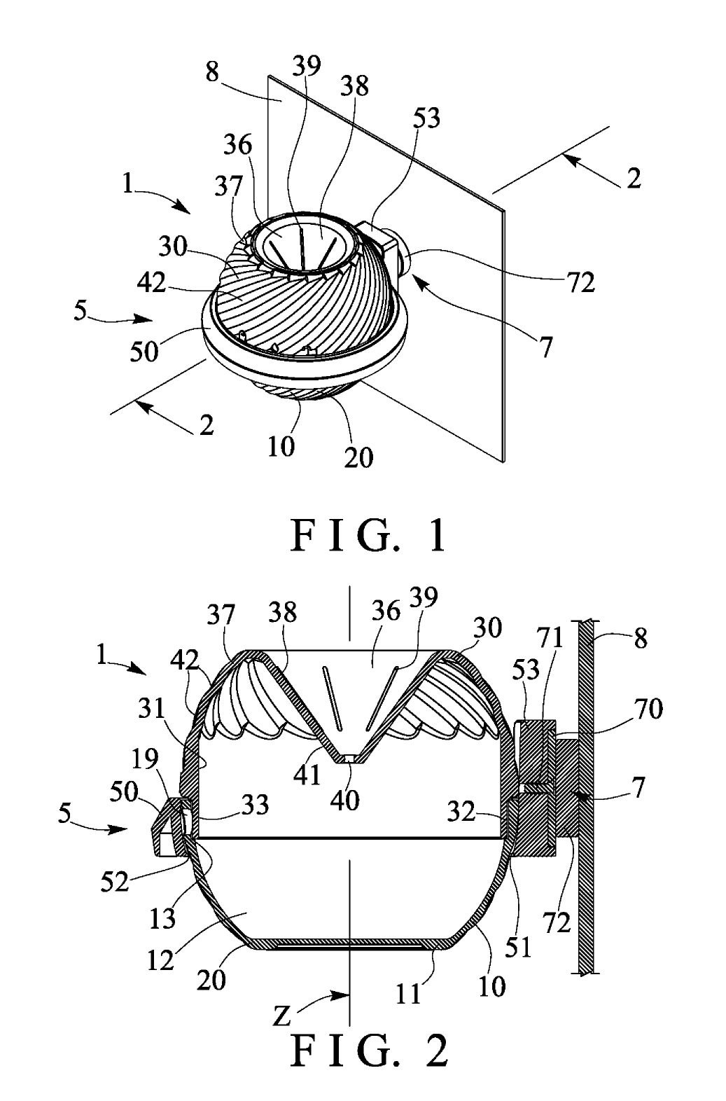

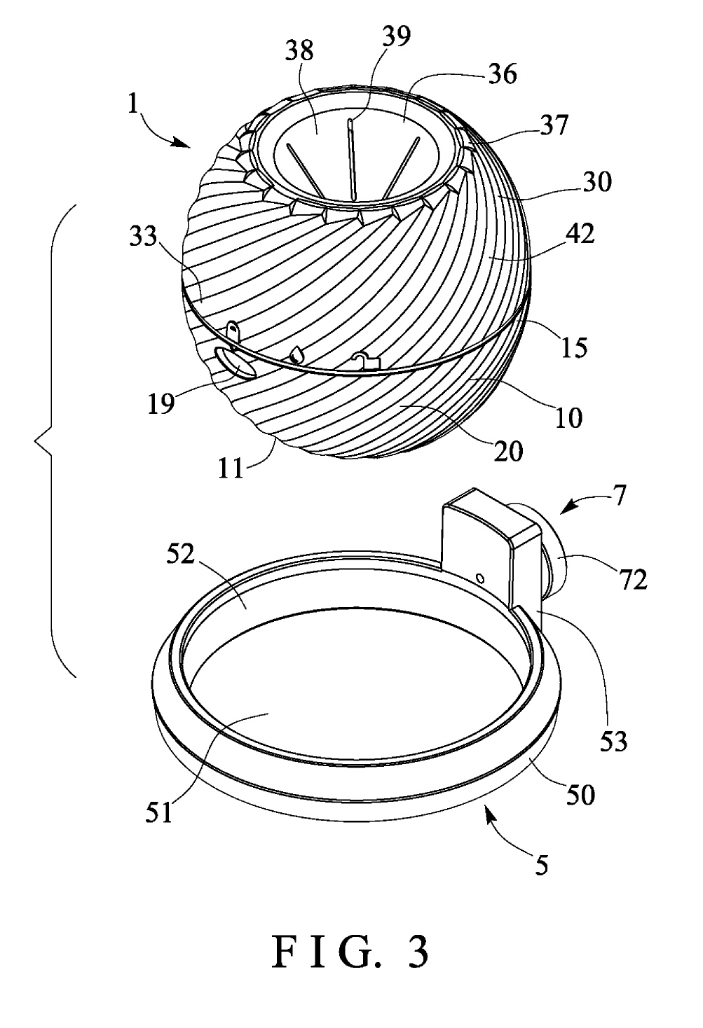

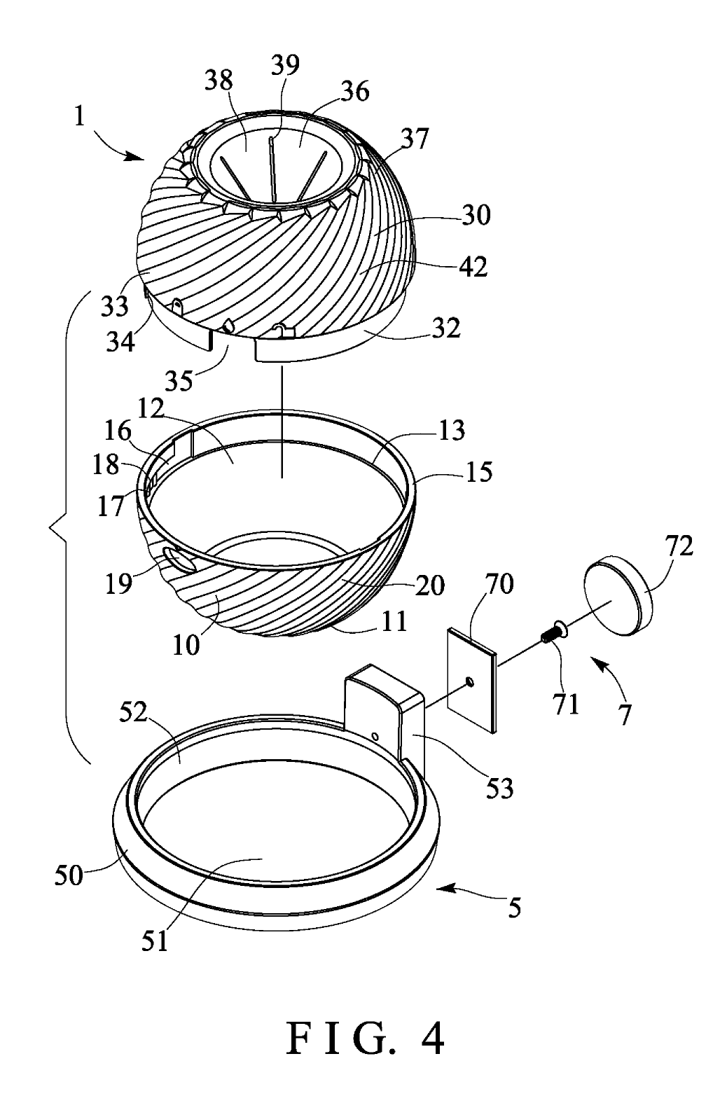

Referring to the drawings, and initially to FIGS. 1-4, a fly catcher combination in accordance with the present invention comprises a receptacle 1, and a supporting carrier 5 including a coupler or attachment 7 for attaching or mounting or securing the supporting carrier 5 and/or the receptacle 1 to various supporting facilities 8, such as the garbage cans, the door panels, the walls, the furniture pieces or the like. For example, the receptacle 1 includes a lower or base housing 10 and an upper casing or cover 30 to be contacted or engaged with each other, for example, the housing 10 includes a lower or bottom or base portion 11 having a planar structure or configuration (FIG. 2) for allowing the housing 10 to be solidly and stably engaged with and supported on a support ground or surface (not illustrated). The housing 10 includes a simultaneously semi-spherical structure or configuration having a compartment or chamber 12 formed therein, and includes an inner peripheral shoulder or recess 13 formed or provided in the inner peripheral portion at the upper peripheral portion 15 of the peripheral wall 14 or of the housing 10, best shown in FIGS. 2 and 4.

The housing 10 includes a groove or channel 16 (FIG. 4) also formed or provided in the inner peripheral portion at the upper peripheral portion 15 of the housing 10 and communicating with the inner peripheral recess 13 and/or the chamber 12 of the housing 10, and the channel 16 of the housing 10 includes a limited length, such as one half of the upper peripheral portion 15 of the housing 10, and includes one or more (such as two) depressions 17, 18 also formed or provided in the inner peripheral portion at the upper peripheral portion 15 of the housing 10 and communicating with the inner peripheral recess 13 of the housing 10 and also communicating with the channel 16 of the housing 10, and includes a circular-shaped orifice 19 formed or provided in the upper peripheral portion 15 of the housing 10 and communicating with the chamber 12 of the housing 10.

The cover 30 also includes a simultaneously semi-spherical structure or configuration having a chamber or compartment 31 formed therein, and includes a peripheral flange 32 extended downwardly from the lower peripheral portion 33 thereof for slidably engaging into or with the inner peripheral recess 13 of the housing 10 and for guiding the cover 30 to pivot or rotate relative to the housing 10 and for preventing the cover 30 from being disengaged or separated from the housing 10, and includes a projection or key 34 extended radially and outwardly from the peripheral flange 32 for selectively engaging into or with either of the depressions 17, 18 of the housing 10 and for slidably engaging into the channel 16 of the housing 10 and thus for guiding and limiting the cover 30 to pivot or rotate relative to the housing 10 and for preventing the cover 30 from being disengaged or separated from the housing 10.

The cover 30 further includes a square or rectangular opening or notch 35 formed therein (FIG. 4) for selectively aligning with the orifice 19 of the housing 10 or for being selectively offset or spaced or disengaged or separated from the orifice 19 of the housing 10 by pivoting or rotating the cover 30 relative to the housing 10, for example, the notch 35 of the cover 30 may be selectively positioned to and aligned with the orifice 19 of the housing 10 when the key 34 is engaged with one end of the channel 16 of the housing 10. The cover 30 further includes a cone-shaped casing 36 extended from the upper portion 37 of the casing 30 into the compartment 31 of the cover 30, and the casing 36 includes a space 38 formed therein and offset or spaced or separated from the compartment 31 of the cover 30 by the cone-shaped casing 36. The compartment 31 of the cover 30 is communicating with the chamber 12 of the housing 10.

The cover 30 further includes one or more slots 39 formed in the casing 36 and communicating with the compartment 31 of the cover 30 and also communicating with the space 38 of the casing 36, and further includes one or more apertures 40 formed in the lower or bottom portion 41 of the casing 36 (FIG. 2) and also communicating with the space 38 of the casing 36 and also communicating with the compartment 31 of the cover 30, and the slots 39 and/or the apertures 40 of the casing 36 and arranged for allowing the flies and/or the mosquitos to easily fly into the compartment 31 of the cover 30, but for preventing the flies and/or the mosquitos from flying out of the casing 36 and of the cover 30. As shown in FIGS. 1-4, the housing 10 may include a number of ribs or a spatial or serrated pattern 20 formed or provided thereon, and/or the cover 30 may also include a spatial or serrated pattern 42 formed or provided thereon for attracting and confusing the flies and/or the mosquitos.

The supporting carrier 5 includes a circular or peripheral frame 50 having a chamber or opening 51 formed therein and formed or defined by a peripheral fence 52, for receiving or engaging with the receptacle 1, and it is preferable that the peripheral fence 52 includes a curved or concave structure or configuration (FIG. 2) for suitably contacting or engaging with the receptacle 1, and for solidly and stably supporting the receptacle 1 in or on the carrier 5 (FIGS. 1, 2); or, it is preferable that the peripheral fence 52 is tilted or inclined relative to the longitudinal or vertical or perpendicular axis (Z, FIG. 2) of the receptacle 1 and/or of the carrier 5 for allowing the receptacle 1 to be solidly and stably supported in the carrier 5 with the peripheral fence 52 of the carrier 5. The carrier 5 includes a flap or ear 53 provided on or extended from the frame 50 for engaging with or for supporting the attachment 7.

The attachment 7 includes one or more (such as two) attaching members 70, 72, such as the magnetic attractive members 70, 72, for example, the first attaching member 70 is attached or mounted or secured to the frame 50, such as the ear 53 of the frame 50 with screws or latches or fasteners 71 or the like, and the second attaching member 72 is acted or attracted with the first attaching member 70 for attaching or mounting or securing the receptacle 1 and the frame 50 to the supporting facility 8, such as the garbage can 8, the door panel, the wall, the furniture piece or the like (FIGS. 1, 2) when the supporting facility 8 is made of metallic materials or magnetic attractive materials. If the supporting facility 8 is not made of metallic materials or magnetic attractive materials, the supporting facility 8 may be disposed or engaged between the magnetic attractive members 70, 72, for allowing the receptacle 1 and the frame 50 to be attached or mounted to the supporting facility 8 with the attaching members 70, 72 of the attachment 7.

In operation, as shown in FIGS. 1 and 2, when the notch 35 of the cover 30 is offset or spaced or disengaged or separated from the orifice 19 of the housing 10, and when some attracting materials (not illustrated), such as fruit or meat or fish or the like, are disposed or engaged into the chamber 12 of the housing 10, the flies and/or the mosquitos (not illustrated) may be attracted and may fly through the slots 39 and/or the apertures 40 of the casing 36 and into the compartment 31 of the cover 30, and may be prevented from flying out of the casing 36 and of the cover 30. The cover 30 may be selectively pivoted or rotated relative to the housing 10 in order to selectively align the notch 35 of the cover 30 with the orifice 19 of the housing 10, and a water or fluid (not illustrated) or the like may be selectively introduced through the notch 35 of the cover 30 and the orifice 19 of the housing 10 and into the compartment 31 of the cover 30 and/or into the chamber 12 of the housing 10.

The receptacle 1 may be easily and quickly disposed or engaged onto the frame 50 and supported on the frame 50, and may also be easily and quickly disengaged or separated from the frame 50, and the frame 50 may be easily and quickly attached or mounted or secured to the supporting facility 8, such as the garbage can 8, the door panel, the wall, the furniture piece or the like with the attaching members or magnetic attractive members 70, 72 of the attachment 7. If the supporting facility 8 is not made of metallic materials or magnetic attractive materials, the magnetic attractive members 70, 72 of the attachment 7 may be disposed or engaged onto the inner portion and the outer portion of the supporting facility 8 for allowing the frame 50 to be attached or mounted to the supporting facility 8 with the attaching members or magnetic attractive members 70, 72 of the attachment 7.

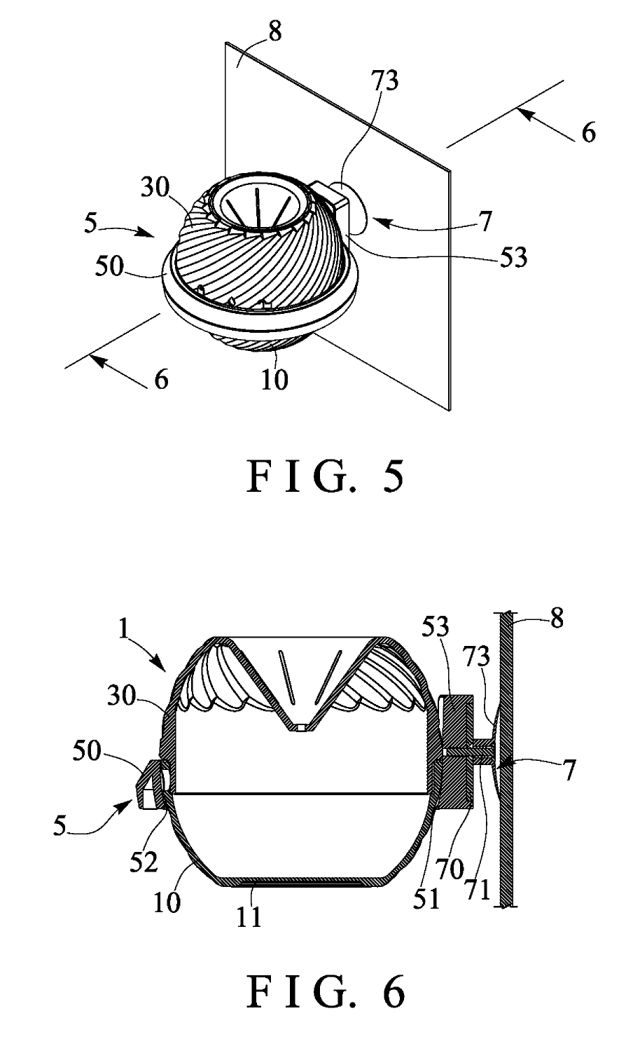

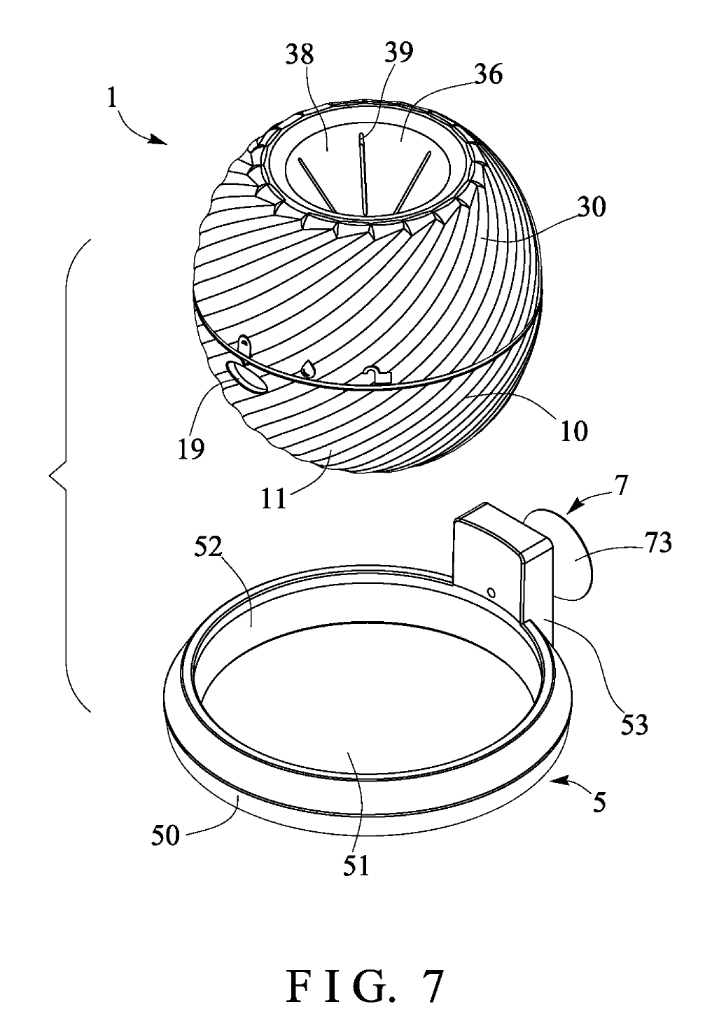

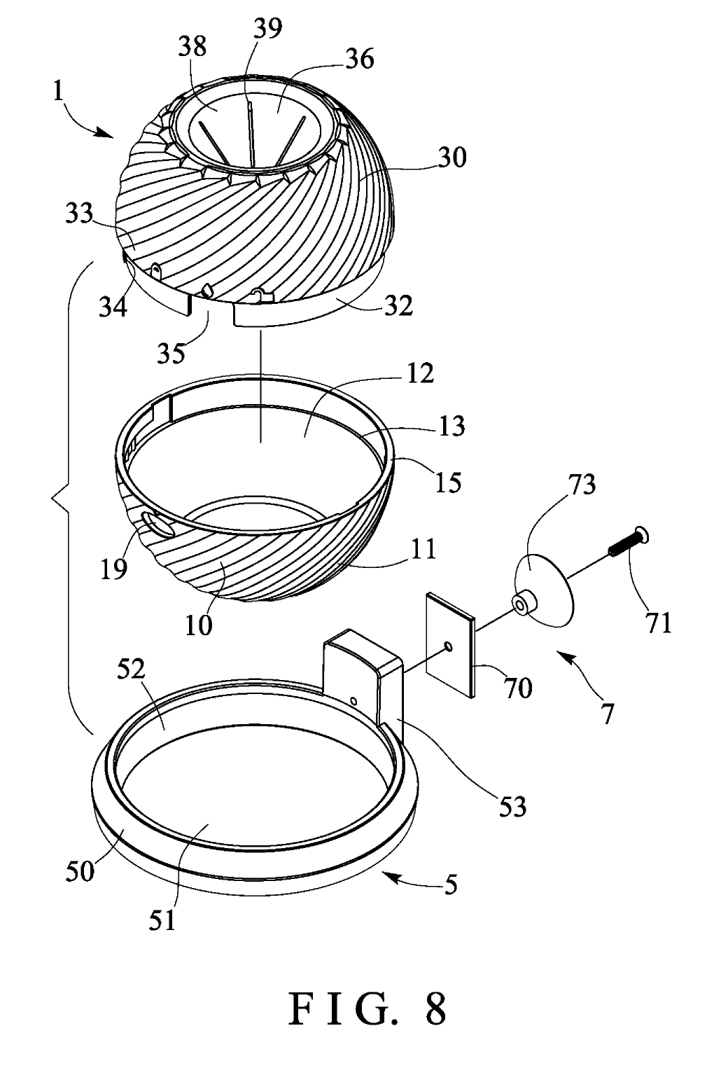

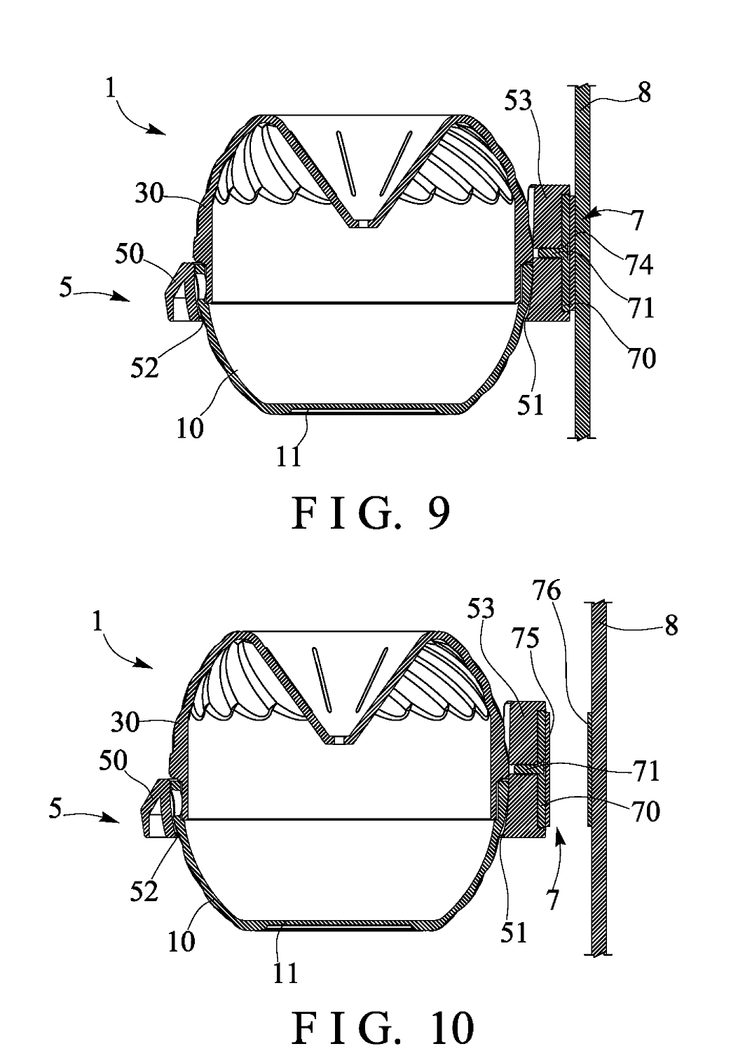

Alternatively, as shown in FIGS. 5-8, the attachment 7 may include one or more (such as two) attaching members 70, 73, such as the gasket or plate 70, and the suction member 73 attached or mounted or secured to the frame 50, such as the ear 53 of the frame 50 with screws or latches or fasteners 71 or the like, for attaching or mounting or securing the receptacle 1 and the frame 50 to the supporting facility 8, such as the garbage can 8, the door panel, the wall, the furniture piece or the like (FIGS. 5 and 6) with the attaching member or suction member 73 of the attachment 7. Further alternatively, as shown in FIG. 9, the attachment 7 may include an attaching member or gasket or plate 70 attached or mounted or secured to the frame 50, such as the ear 53 of the frame 50 with screws or latches or fasteners 71 or the like, and an adhesive layer or member 74 attached or mounted or secured to the plate 70 for attaching or mounting or securing the receptacle 1 and the frame 50 to the supporting facility 8 with the adhesive member 74 of the attachment 7.

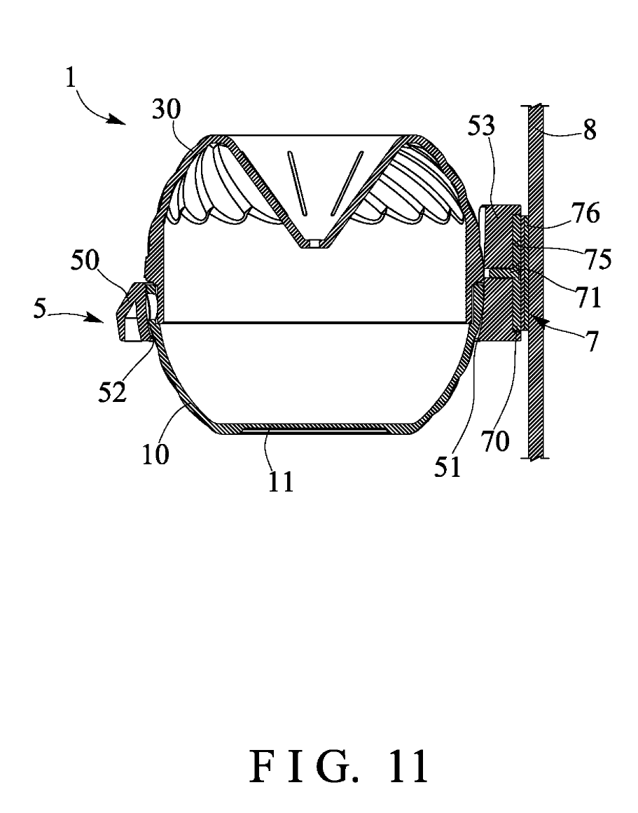

Further alternatively, as shown in FIGS. 10 and 11, the attachment 7 may include one or more (such as two) attaching members 75, 76, such as the hook-and-loop attaching members 75, 76 attached or mounted or secured to the frame 50, such as the ear 53 of the frame 50, and the supporting facility 8 respectively for allowing the receptacle 1 and the frame 50 to be attached or mounted to the supporting facility 8 with the attaching members 75, 76 of the attachment 7. The receptacle 1 may be easily and quickly disposed or engaged onto the frame 50 without additional fastening devices or members, and may also be easily and quickly disengaged or separated from the frame 50.

Accordingly, the fly catcher combination in accordance with the present invention includes an improved and simplified structure or configuration that may be easily and quickly made or manufactured by the workers with a simplified making or manufacturing procedure and with a decreased manufacturing cost, and that may be easily and quickly attached or mounted or secured or coupled to various supporting facilities or the like.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A fly catcher combination comprising:
a carrier including a frame having an opening formed therein and defined by a peripheral fence,
an attachment attached to said frame of said carrier for attaching said frame of said carrier to a supporting facility, and
a receptacle engaged in said opening of said frame and supported on said frame, and said receptacle including a housing having a chamber formed in said housing, and a cover engaged with said housing, and said cover including a compartment formed in said cover and communicating with said chamber of said housing, and said cover including at least one slot formed therein and communicating with said compartment of said cover.

2. The fly catcher combination as claimed in claim 1, wherein said carrier includes an ear extended from said frame for engaging with and for supporting said attachment.

3. The fly catcher combination as claimed in claim 1, wherein said attachment includes a first attaching member attached to said frame.

4. The fly catcher combination as claimed in claim 3, wherein said attachment includes a second attaching member engaged with said first attaching member.

5. The fly catcher combination as claimed in claim 4, wherein said first and said attaching members are selected from magnetic attractive members for attracting with each other.

6. The fly catcher combination as claimed in claim 4, wherein said first and said attaching members are selected from hook-and-loop attaching members.

7. The fly catcher combination as claimed in claim 3, wherein said first attaching member of said attachment is selected from an adhesive material.

8. The fly catcher combination as claimed in claim 1, wherein said housing includes an orifice formed therein and communicating with said chamber of said housing, and said cover includes a notch formed therein for selectively aligning with said orifice of said housing when said cover is rotated relative to said housing.

9. The fly catcher combination as claimed in claim 1, wherein said cover includes a casing extended from an upper portion of said casing into said compartment of said cover, and said casing includes a space formed therein and spaced from said compartment of said cover by said casing, said casing includes an aperture formed therein and communicating with said space of said casing and communicating with said compartment of said cover.

10. The fly catcher combination as claimed in claim 9, wherein said at least one slot of said cover is formed in said casing and communicating with said compartment of said cover.

11. The fly catcher combination as claimed in claim 1, wherein said housing includes a peripheral recess formed in an upper peripheral portion of said housing, and said cover includes a peripheral flange extended downwardly from a lower peripheral portion of said cover for slidably engaging with said peripheral recess of said housing and for guiding said cover to rotate relative to said housing.

12. The fly catcher combination as claimed in claim 11, wherein said housing includes a channel formed therein, and said cover includes a key extended from said peripheral flange for slidably engaging with said channel of said housing and for guiding and limiting said cover to rotate relative to said housing.
